(19) United States
(12) Patent Application Publication
(10) Pub. No.: US 2022/0340472 A1
(43) Pub. Date: Oct. 27, 2022

(54) PANE-SHAPED GLASS ELEMENT AND METHOD OF SEPARATING A GLASS SUBSTRATE INTO A PLURALITY OF SUCH GLASS ELEMENTS

(71) Applicant: FLABEG DEUTSCHLAND GMBH, Furth im Wald (DE)

(72) Inventors: Joachim EBMEIER, Furth im Wald (DE); Jeremy RENDELL, West Midlands (GB)

(73) Assignee: FLABEG AUTOMOTIVE GERMANY GMBH, Furth im Wald (DE)

(21) Appl. No.: 17/764,555

(22) PCT Filed: Sep. 30, 2020
(86) PCT No.: PCT/EP2020/077413

§ 371 Date: Mar. 29, 2022

(30) Foreign Application Priority Data
Oct. 2, 2019 (DE) 10 2019 215 264.3

(51) Int. Cl. C03B 33/02; B23K 26/402; B23K 26/38; B23K 26/0622

(52) U.S. Cl. CPC C03B 33/0222; B23K 26/402; B23K 26/38; B23K 26/0622

(57) ABSTRACT

A pane-shaped glass element having two opposing side surfaces which are edge-wise interconnected by a number of edge surfaces, wherein in the or each edge surface there are provided filamentary damages forming side-by-side elongate depressions, and wherein the or each edge surface lies obliquely to the side surfaces, is to be further formed for particularly good usability in a plurality of possible applications. For this purpose, according to the invention, the respective edge surface has a surface roughness with a mean roughness value of at least 0.3 μm, and preferably of at most 2 μm, in a particularly advantageous embodiment of about 1 μm, in its region provided with the filamentary damages.

### CROSS-REFERENCE TO RELATED APPLICATIONS

This application is a national stage application of the Patent Cooperation Treaty (PCT) international application titled “Planar Glass Element And Method For Separating A Glass Substrate Into A Plurality Of Such Glass Elements”, international application number PCT/EP2020/077413, filed in the European Patent Office on Sep. 30, 2020, which claims priority to and the benefit of the non-provisional patent application titled “Disc-Shaped Glass Element And Method For Separating A Glass Substrate Into A Plurality Of Such Glass Elements”, non-provisional patent application number DE102019215264, filed in the German Patent Office on Oct. 2, 2019. The specifications of the above referenced patent applications are incorporated herein by reference in their entirety.

### FIELD OF THE INVENTION

The invention relates to a pane-shaped glass element having two opposing side surfaces joined edgewise by a number of edge surfaces, wherein there are provided in the or each edge surface filamentary damages forming side-by-side elongate depressions, and wherein the or each edge surface is oblique to the side surfaces. It further relates to a method of separating a glass substrate into a plurality of such glass elements, in which a perforation formed by a sequence of filamentary damage is created in the glass substrate along an intended cut line by means of a perforation laser, and the glass substrate is subsequently broken along the perforation, the perforation laser being set to impinge the laser beams on the glass substrate at an angle relative to the surface normal of the glass substrate.

### BACKGROUND

A variety of processes and concepts can be used to cut or separate glass or glass elements. Among other things, laser-based processes such as laser filament cutting can be used, especially with regard to complex cutting shapes or high precision requirements.

Laser filament cutting, also known as filamentation, makes use of non-linear optical effects. For this purpose, a suitably selected laser—also referred to below as a “perforating laser”—is used, the focus of which is placed under the glass surface of the glass element to be cut and into the material. Due to the so-called self-focusing, there is local heating in the glass material at the point where the focal point is located, the formation of local stresses and a change in the refractive index. As a result, the initially small volume element acts like a lens, and in its continuation, further such filaments can be generated. If the laser beam is guided over the glass in this process, a so-called filament curtain is created, which acts in the manner of a perforation and can serve as a starting point for a subsequent separation step, for example by breaking. This concept of laser filamentation is known, for example, from US 2013/0126573 A1.

From DE 10 2015 111 491 A1, a pane-shaped glass element of the type mentioned at the beginning is known, in which the lateral separation edge created by the introduced perforation formed by the filamentary damage during the subsequent separation or fracture process is made oblique, i.e. inclined relative to the surface normal. This is achieved by setting the perforation laser used to create the perforation in the glass substrate with its laser beam at an angle or inclination to the surface of the glass substrate. According to the teaching of DE 10 2015 111 491 A1, the resulting inclined or slanted separating or edge surface of the glass element is intended to make it particularly easy to detach inner contours when separating the glass elements, even in the case of complex contours or cutting lines.

### SUMMARY OF THE INVENTION

The invention is now based on the task of further developing a glass element of the above-mentioned type for particularly good usability in a multitude of possible applications. Furthermore, a particularly suitable method of the above-mentioned type for the manufacture of the glass element is to be specified.

With regard to the glass element, this task is solved according to the invention in that the respective beveled edge surface has, in its region provided with the filamentary damages, a surface roughness with a mean roughness value of at least 0.3 μm, and preferably of at most 2 μm, in a particularly advantageous embodiment of about 1 μm.

The invention is based on the consideration that the beveled edge or rim guide actually provided in the known glass element for reasons of facilitated separation or product separation could be used as a basis for an advantageous further development of the glass element in the sense of an improvement of the product properties for its later use. In particular, it can be taken into account that such a beveled side edge is visually conspicuous and can thus be visually recognized more easily than conventional, “straight” edges during both manual and mechanical further processing. Alternatively or in addition, such a beveled side edge can be made particularly suitable for subsequent bonding. In order to improve the glass element specifically with regard to these two functionalities, i.e. easier optical recognition and/or improved suitability for bonding, the roughness or roughness of the surface in the area of the edge surface or edge surfaces is now provided as a parameter suitable for this.

In particular, it is taken into account that the roughness on the one hand is an indication of the optical detectability. Furthermore, the degree of gloss is a criterion, but also the scattered light (diffusion) due to the typical fracture surface with many small individual surfaces, as glass breaks brittly. In particular, it must be taken into account that normal broken or processed glass edges are often difficult to recognize. The contrast is usually low because it is a transparent material whose surfaces can often also be reflective. In particular, laser modification cutting with the standard process creates high-quality surfaces that are relatively inconspicuous in the direction of the surface normal. This can now be taken into account in the finished glass element in particular by the fact that in comparison with the directly adjacent surface areas of the side surfaces of the glass element, which usually have an extremely low surface roughness, a contrast can be specifically created through the roughness now provided, through which the recognizability can be significantly improved. On the other hand, the intended surface roughness is particularly favorable for bonding, as in this way it is particularly easy to create an intimate material contact with an adhesive.

The demarcation of the “area provided with filamentary damage” from the other areas of the edge surface is preferably carried out on the basis of the criterion that the individual filaments are usually set at a constant nominal distance from each other, so that the “area provided with filamentary damage” ends where the next adjacent filament is set at a distance of more than twice this nominal distance from the respective filament.

Advantageous embodiments of the invention are the subject of the subclaims.

Particularly with regard to the usually selected other parameters of such a glass element, such as the glass thickness or the lateral expansion, the respective beveled edge surface in its area provided with the filamentary damages very preferably has a surface roughness with a mean roughness value of about 1 μm.

In a particularly advantageous further development, other geometric parameters of the glass element are also specifically selected to support the functionalities to be improved. In a departure from the design criteria provided in the known glass element with the design objective of facilitating separation of the elements from one another, the edge surface is now particularly preferably inclined by an angle of inclination of 0.5° to 3° relative to the surface normal of the side surfaces. This means that comparatively small angles of inclination of the edge surface relative to the surface normal of the side surfaces are particularly preferred. In particular, a combination of design criteria is taken into account in the choice of parameters for the angle of inclination in a very particularly preferred design: on the one hand, there is a general endeavor to avoid generally deviating angles, since 90° angles are often also specified on the component side. In this sense, comparatively small angles would be desirable. An increase in the angle, on the other hand, means increasingly easier recognition; a doubling of the machined surface in the top view generally also means twice as good visibility. From this point of view, larger angles of inclination would be preferable—preferably in compliance with the boundary conditions specified on the component side.

As has also surprisingly turned out, the effects and functionalities achievable through the targeted adjustment of the surface roughness are particularly well usable for glass elements of comparatively low thickness. Particularly preferably, the glass element therefore has a thickness of at most 6 mm, preferably at most 3 mm.

With regard to the process, the above-mentioned task is solved in that the filaments forming the perforation are produced in the glass substrate in such a way that the edge surface resulting after breaking and exhibiting the damages caused by the filaments has a surface roughness with a mean roughness value of at least 0.3 μm, and preferably of at most 2 μm, in a particularly advantageous embodiment of about 1 μm.

Particular account is taken of the fact that the optical quality of the edge is decisive for its recognizability. In addition to the material properties such as optical density, interface size in the fracture pattern, brittleness, and the like, it is determined by the processing (polished, ground, broken, etc.). In laser modification cutting, the surface of the edges consists of at least two surface portions, namely the filament itself and the fracture area between the filaments. The edge surface and especially its surface roughness can be influenced by the number, the dimensioning, the position and also the design of the filaments. A large number of filaments with small dimensions and close spacing result in a surface with a comparatively low roughness. Large filaments, on the other hand, increase the surface roughness. The half channel created by the modification in the middle of a break is part of the surface and thus also contributes to the surface roughness. The fracture area between the modifications determines the rest of the surface properties. When setting the surface roughness, the ratio of free fracture area to filament fracture area must therefore also be taken into account. Furthermore, it is also conceivable to-introduce deliberately pronounced (e.g. particularly large or small, . . . ) modifications at fixed intervals in addition to the normal ones in order to achieve the desired surface roughness.

Advantageously, during the production of the perforation or the filaments forming it, the perforation laser is set at an angle to the surface normal of the glass substrate in such a way that the filamentary damages forming in the glass substrate are inclined with their longitudinal direction relative to the surface normal of the glass substrate by an angle of inclination of between 0.5 ° and 3 °. It may have to be taken into account that—given the laws of refraction—the filament axis direction in the glass substrate does not necessarily correspond to the laser propagation direction, i.e. the direction of the laser beams impinging on the substrate.

Notwithstanding the explained achievable improvement of the functional properties of the glass element through the intended adjustment of the surface roughness in the area of the edge surfaces, the inclined design of the edge surfaces also offers the already known advantages in the removal or separation of the glass elements during the separation of the glass substrate. During the separation of the components from adjacent components or surrounding material, the inclined cut has a positive effect, especially in a removal direction parallel to the surface normal, as this provides a removal inclination. The components are generally interlocked by the surface roughness. The removal slope, i.e. the opening, diverging orientation in the removal direction, reduces the risk of damage during removal due to scallops or edge chipping. Automation of the removal process is thus facilitated or even made possible by the removal slope. To further facilitate this, in alternative or additional advantageous further development, which is moreover considered to be independently inventive, additional measures are provided for facilitating the separation or separation of the glass elements from one another. For this purpose, the glass substrate is advantageously locally heated or locally cooled in a region in the vicinity of the perforation after the introduction of the filamentary damages. In this way, thermal or mechanical stresses are specifically generated in the vicinity of the perforation of the glass substrate, which increase the separation gap and thus reduce the “interlocking” during removal.

The advantages achieved with the invention consist in particular in the fact that the glass element can be strengthened and improved for a multitude of subsequent uses and with regard to its functionalities by the targeted adjustment of the surface roughness of the edge surface. In addition to the simplification of the removal or separation of the components, which can in principle be achieved by the beveled edge surfaces, as provided in the present case, but also by comparatively small angles of inclination, it is also possible to achieve simplified further processing, including automated processing, as a result of the improved visual recognizability, and/or improved bondability.

In particular, users of the glass element, e.g. when installing it in complex systems or when processing it into the end product, may view the process-related damage caused by laser filamentation critically for aesthetic or process-related reasons, e.g. because of stray light caused by edge damage such as shells when light is coupled in, e.g. for displays. Such disturbing effects can be kept to a minimum, especially due to the improved removal of components, even when cutting at an angle that deviates only slightly from 90°. Especially for the comparatively small component thicknesses that are particularly preferred, these deviations are not considered to be particularly disturbing or are accepted. The targeted use of the edge surface properties provided for here can thus improve detectability without having to accept the disadvantages mentioned.

### BRIEF DESCRIPTION OF THE DRAWINGS

An embodiment of the invention is explained in more detail with reference to a drawing. Shown therein is:

FIG. 1 illustrates a schematic of a cutting system for cutting glass elements.

FIG. 2 illustrates a schematic section of a glass substrate with inserted filaments.

FIG. 3 illustrates a glass element.

### DETAILED DESCRIPTION OF THE INVENTION

Identical parts are marked with the same reference signs in all figures.

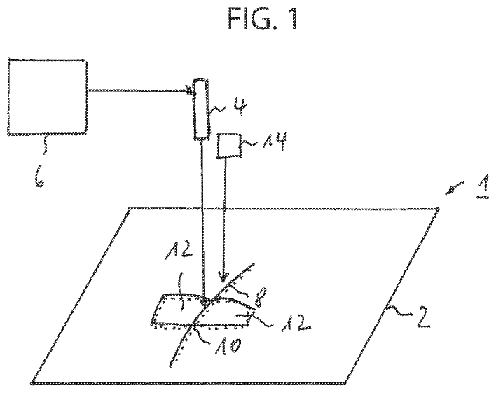

The cutting system 1 according to FIG. 1 is intended for cutting glass substrates 2 by laser filament cutting. For this purpose, the cutting system 1 comprises a perforation laser 4 designed for filament cutting, which laser can be controlled via an associated control device 6. Via the control by means of the control device 6, the focal point of the perforation laser 4 can be guided along a predeterminable cutting line 8 on the surface of the glass substrate 2 to be cut. As a result of the design of the perforation laser 4, local heating in the glass material occurs at the point where the focal point is located, and so occurs the formation of local stresses and a change in the refractive index, so that ultimately, as a result of non-linear optical effects, so-called filaments are formed in the glass material along the cutting line 8, which form the desired perforation 10.

For the actual cutting of the glass substrate 2, hence for its separation into individual glass elements 12, i.e. for the separation of the parts along the cutting line 8 and the perforation 10, a breaking process is provided subsequent to the filamentation, i.e. after the insertion of the perforation 10. To facilitate or support the disunion or separation of the glass elements 12 from each other, the introduction of thermal or mechanical stresses in the vicinity of the introduced perforation 10 of the glass substrate 2 is provided. For this purpose, in the example embodiment, the glass substrate 2 is locally heated in a region in the vicinity of the perforation 10 after the filaments forming the perforation 10 have been introduced; alternatively, however, local cooling could also be provided. In the example embodiment, a heating device 14 that can be positioned locally relative to the surface of the glass substrate 2 is provided for the purpose of local heating.

The cutting system 1 is designed to facilitate the removal or separation of the glass elements 12 produced during separation. In particular, the knowledge is taken into account that in principle a gap-free separation is produced during perforation or modification laser cutting. If the glass elements 12 are then to be separated from each other or from the surrounding bulk material, this is often not possible without causing damage. Furthermore, separation and removal is made more difficult with increasingly complex cutting patterns such as radii, corners or polygons. Typical removal damages are shells, chipping or cracks at the separation edges. In order to counteract this and to facilitate the removal or separation of the glass elements 12, the perforation laser 4 is adjusted for an inclined impingement of the laser beams on the glass substrate 2 relative to the surface normal of the glass substrate, indicated by the arrow 16, when the filaments forming the perforation 10 are introduced.

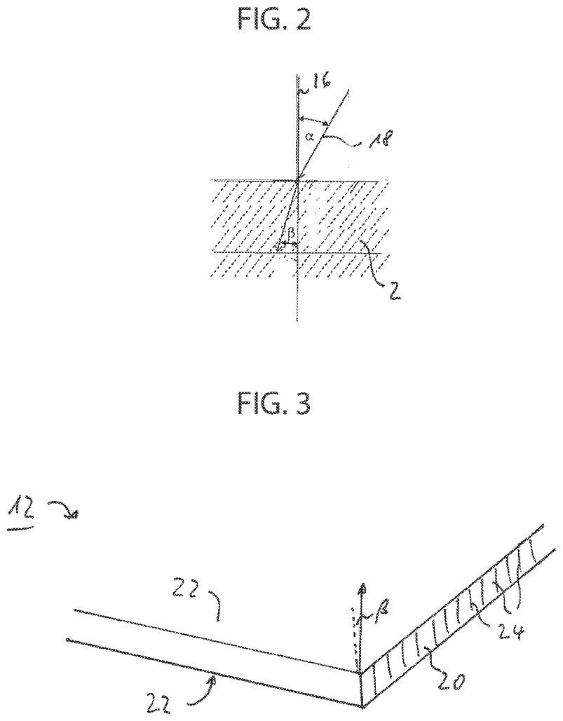

This oblique or inclined impingement of the laser beams results in the filamentary damage produced in the glass substrate 2 also being inclined or oblique to the surface normal of the glass substrate 2. This is shown schematically in FIG. 2. As can be seen there, the laser pulses 18 arriving at an angle α relative to the surface normal of the glass substrate 2 are refracted in the glass substrate 2. Due to the light refraction, the light propagates within the glass substrate 2 at a refractive index n of the material of the glass substrate 2 with an angle β relative to the surface normal, which can be derived from the angle of incidence of the laser pulses 18 according to the relationship sin ß=(1/n) sin α. Consequently, obliquely incident laser pulses 18 also cause oblique modifications or filamentary damage in the glass substrate 2.

During the subsequent breaking or separating of the glass substrate 2, glass elements 12 with sloping or inclined edge surfaces 20 are accordingly produced. As can be seen from the enlarged sectional representation in FIG. 3, the result of the separation process is thus a pane-shaped glass element 12 with two opposing side surfaces 22, which are connected to each other edgewise by a number of edge surfaces 20. The edge surface 20 is tilted or inclined by the angle of inclination β with respect to the surface normal of the side surface 22, i.e. it runs obliquely with respect to the side surfaces 22. As a result of the process and production, filamentary damages 24 forming elongated depressions running next to one another are present in the edge surface 20 as relics of the perforation 10 previously made in the glass substrate 2.

In addition to the facilitation of removal and separation achieved by the inclined orientation of the edge surface 20, the glass element 12 is designed for particularly good usability in a variety of possible applications. This is based on the realization that the beveled edge surface 20 can be specifically refined in the sense of providing additional functionalities, in this case in particular optical recognizability and/or bondability. In order to achieve this, the edge surface 20 has a surface roughness with a mean roughness value of approximately 1 μm in its area provided with the filament-shaped damages 24.

The intended surface roughness is set during the filamentation step by suitable parameter selection and process control. In particular, the number, the dimensioning, the position and also the design of the filaments are essential parameters for the resulting surface roughness, and they are suitably selected and adjusted according to the desired surface roughness. Furthermore, it is also conceivable to introduce deliberately pronounced (e.g. particularly large or small, . . . ) modifications at fixed intervals in addition to the normal ones in order to achieve the desired surface roughness.

For the sake of improved comprehensibility, in particular with regard to the angle of inclination of the edge surface 20, the illustration in FIG. 3 is to be understood merely as a schematic sketch and is not to scale. With regard to its dimensions and geometrical parameters, the glass element 12 is rather designed in the example embodiment with a comparatively small angle of inclination β of the edge surface 20 with respect to the surface normal of the side surfaces 22 of about 2°. This takes account of a large number of design criteria in a particularly favorable manner. In particular, such a choice of the angle of inclination β can, on the one hand, form a sufficient removal slope facilitating removal or separation, whereby, on the other hand, interfering effects such as stray light due to edge damage such as shells can be kept particularly low when light is coupled in, e.g. for displays. Due to the intended surface roughness of the edge surface, it is nevertheless possible to provide significantly improved visual recognition and also improved adhesiveness, especially for the comparatively small inclination angles β provided.

List of reference signs

1 cutting system

2 glass element

4 perforation laser

6 control device

8 cutting line

10 perforation

12 glass element

14 heating device

16 arrow

18 laser pulse

20 edge surface

22 side surface

24 damage

1-7. (canceled).

8. A pane-like glass element having two opposing side surfaces which are edgewise interconnected by a number of edge surfaces, wherein in the or each edge surface there are provided filamentary damages forming juxtaposed, elongate depressions, and wherein the or each edge surface lies obliquely relative to the side faces, wherein the respective edge surface has a surface roughness with a mean roughness value of at least 0.3 μm in its region provided with the filamentary damages, characterised in that the edge surface is inclined by an angle of inclination of 0.5° to 3° relative to the surface normal of the side surfaces.

9. The pane-like glass element of claim 1, the respective edge surface of which has, in its region provided with the filamentary damage, a surface roughness with a mean roughness value of at most 2 μm, advantageously of about 1 μm.

10. The pane-like glass element of claim 1, which has a thickness of at most 6 mm, preferably at most 3 mm.

11. The pane-like glass element of claim 9, which has a thickness of at most 6 mm, preferably at most 3 mm.
